(19) United States
(12) Patent Application Publication
(10) Pub. No.: US 2008/0044248 A1
(43) Pub. Date: Feb. 21, 2008

(54) Marsupial fifth wheel tractor

(76) Inventor: Leon Orville Clutterham, Eugene, OR (US)

Correspondence Address: LEON ORVILLE CLUTTERHAM, 3994 CENTURY DRIVE, EUGENE, OR, 97402, US

(21) Appl. No.: 11/506,851

(22) Filed: Aug. 18, 2006

(51) Int. Cl. B60P 3/06

(52) U.S. Cl. 410/4

(57) ABSTRACT

A vehicle designed to tow conventional and fifth wheeled hitched trailers while loading, un-loading and carrying an auxiliary automobile with in the vehicles interior and a number of occupants plus temporary living quarters for those occupants.

### BACKGROUND OF THE INVENTION

This invention related generally to a tractor suitable for towing fifth wheel trailers and commercial/sport trailers of similar size and weight while transporting an automobile onboard the tractor to be employed as an auxiliary form of transportation.

### SUMMARY OF THE INVENTION

The invention is directed to a mid engine (but nor limited to) tractor for trailer towing with the ability to load, unload and carry an auxiliary vehicle within the interior of the tractor. Further, loading and unloading is accomplished from the passenger side of the tractor, irrespective of trailer attachment.

### BRIEF DESCRIPTION OF THE DRAWINGS

FIG. 1 is a side view of the tractor with the auxiliary vehicle onboard and fifth wheel trailer attached according to the invention.

FIG. 2 is a perspective view showing the right and front side of the tractor with the auxiliary vehicle in the down or un-load position according to the invention.

FIG. 3 is a perspective of the tractor from the right and rear of the tractor showing the auxiliary vehicle in the up loaded position ready to slide into the tractor where upon the side compartment door will close fully housing the auxiliary vehicle.

### DETAILED DESCRIPTION OF THE INVENTION

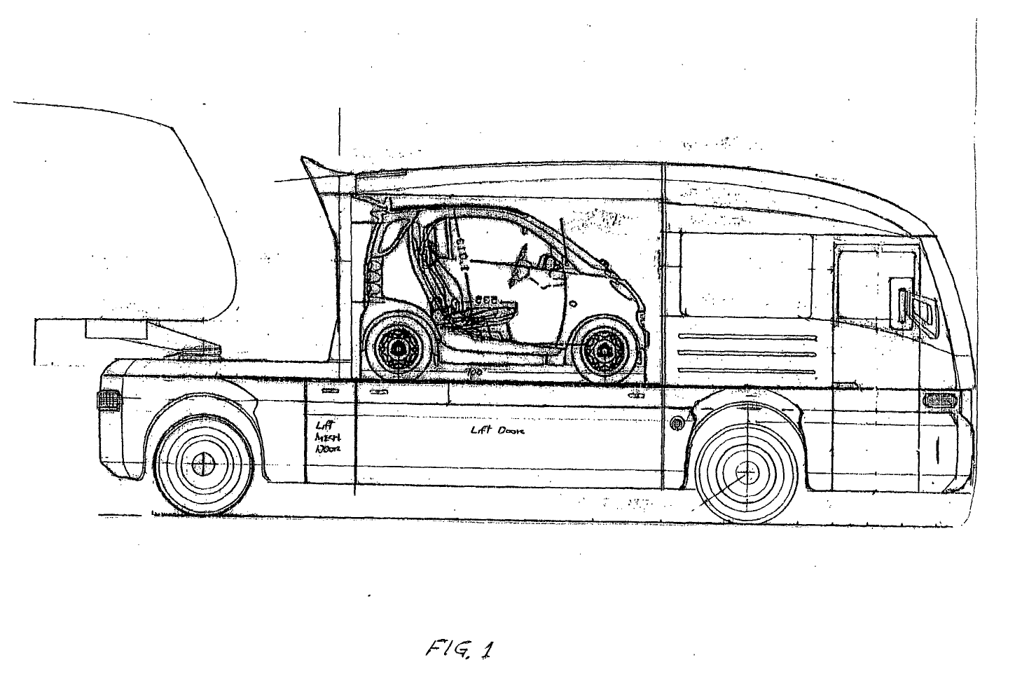

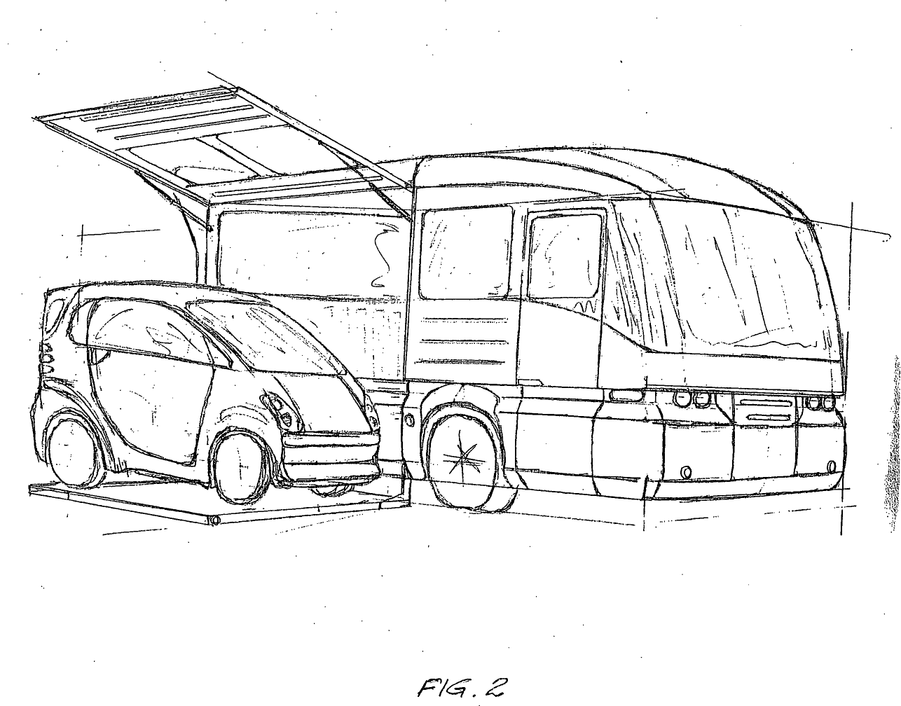

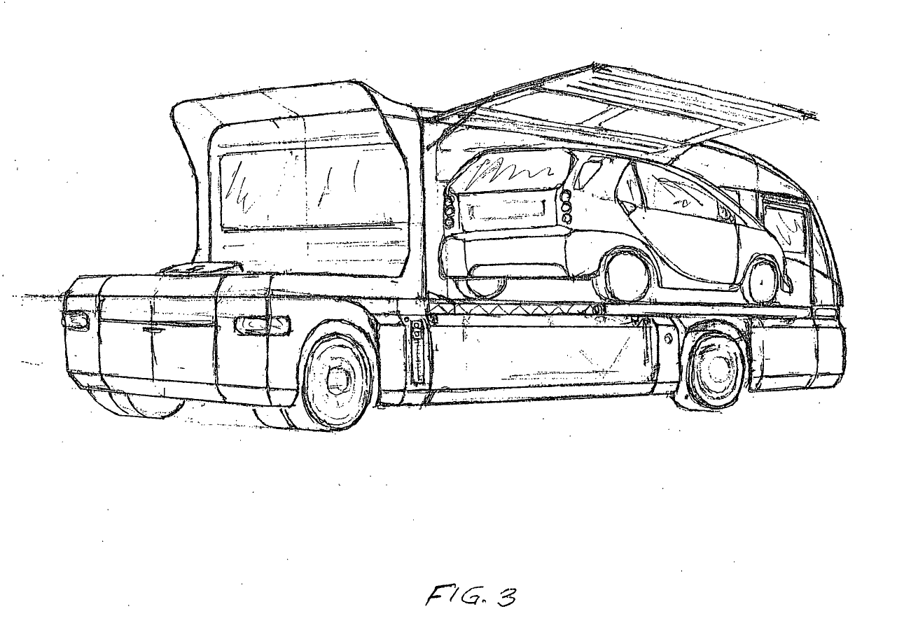

As shown in FIG. 1, a tractor according to the invention, fashioned to be of minimum length while providing full height standing room for occupants, the carrying of an auxiliary vehicle for those occupants and the means to load and un-load the auxiliary vehicle as shown in FIG. 2 and FIG. 3. Further the vehicle has the ability to tow fifth wheel hitched trailers.

What is claimed is:

1. A vehicle (tractor) specially designed to tow conventional and fifth wheel hitched trailers as used for recreation and commerce.

2. The specially designed tractor carries several occupants and provides for full height standing room throughout and limited temporary living accommodations.

3. The specially designed tractor is of minimum length with the power plant located with in the wheel base.

4. The specially designed tractor has the ability to lift, lower and store an auxiliary vehicle with in its interior providing a secondary mode of transportation for its occupants. This apparatus to providing lifting, lowering and enclosed storage on board does so from the right hand or passenger side of the tractor.

5. Loading, unloading and storage of the auxiliary vehicle may be accomplished irrespective of other uses of the tractor.
